(19) United States
(12) Patent Application Publication
(10) Pub. No.: US 2003/0052796 A1
(43) Pub. Date: Mar. 20, 2003

(54) Service mediator system for vehicles and vehicle users in a traffic network

(75) Inventors: Johan Richard Schmidt, Leiden (NL); Wim Van Den Berg, Gouderak (NL)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: Koninklijke KPN N.V.

(21) Appl. No.: 10/244,689

(22) Filed: Sep. 16, 2002

(30) Foreign Application Priority Data
Sep. 17, 2001 (EP) 01203515.0
Sep. 26, 2001 (NL) 1019038

(51) Int. Cl. G08G 1/09

(52) U.S. Cl. 340/905; 340/901; 340/988

(57) ABSTRACT

System for controlling vehicles in a traffic network. The vehicles (4) comprise communication means (5), for communication, via a communication network (2), with a service mediator system (1), linking the vehicle's communication means to various servers (9a . . . i). The vehicle may comprise means (6) for exchanging data between the vehicles' software or hardware, while at least one of said servers comprises means for processing said data related to the vehicles' software or hardware, like fuel consumption and the vehicles' maintenance state. The vehicle's communication means may comprise location means, enabled for exchanging data relative to the vehicles' location to be used for planning and scheduling the use of the vehicles, route planning, billing vehicle related tax or insurance. One or more servers may be enabled to process requests for vehicle parking or for hiring alternative transportation room or means. One server may be enabled for automatic processing vehicle accidents.

### FIELD OF THE INVENTION

The present invention relates to a service mediator system intended for service provisioning to vehicles and vehicle users in a traffic network.

### BACKGROUND OF THE INVENTION

Car traffic nowadays is subject to increasing society concern due to problems such as environment polution and traffic congestion. Suggested and implemented measures comprise tax and technological measures.

### SUMMARY OF THE INVENTION

It is an aim of the present invention to provide a framework for enhanced allocation and mutual tuning of different mobility resources like public and private transportation services, road and parking capacity, traffic routing, route information, and accounting and billing. One of the aspects of the present invention is that all participating vehicles comprise local communication means, enabled to communicate, via a communication network, with a service mediator system, enabled to link said local communication means to various servers, via e.g. an (IP based) server network like the internet.

In an embodiment of the invention, each vehicle contains a “car box” which is enabled to communicate—via mobile communication protocols such as GSM, GPRS or UMTS—with a central or distributed mediator system. Said mediator system serves as a central connection point for all kinds of services—enabled by various servers—relevant for traffic control, vehicle control and for user services like maintenance, accounting and billing of taxes, insurance fees etc, and for (business and private) communications.

The local communication means (the “car box”) may comprise means for exchanging data between the vehicles' software or hardware, while at least one of said servers comprises means for processing said data related to the vehicles' software or hardware. For instance one of said servers may register the vehicles' fuel consumption and advise the car driver about the distance and the way to a fuel pump. More sophisticated may be the option that one of said servers comprises means for registering the vehicles' maintenance state and notifying the driver to visit a maintenance or repair workshop. More options in the domain of monitoring the hardware or software of vehicles are possible.

The local communication means may also comprise vehicle location means, enabled for exchanging data relative to the vehicles' location, while at least one of said servers comprises means for processing said location data. This also is a domain which opens many sophisticated services, for instance based on registering, in one of said servers, the vehicles' locations.

At least one of said servers may comprise means for planning and scheduling the use of the vehicles. This option may for instance enable sophicated “just-in-time” car leasing (instead of present permanent car leasing practice).

At least one of said servers may comprise means for dynamic (self-adapting to changes in traffic streams and capacity fluctuations) route planning.

At least one of said servers may comprise means for sophisticated billing or taxing for the use of the vehicles, for instance dependent on vehicle (engine) characteristics, fuel consumption, location, speed, time-of-the-day, etc. At least one of said servers may comprise means for billing vehicle related insurance.

Said local communication means may comprise means for the exchange of voice or data with the vehicles' “users” (users, drivers), while at least one of said servers comprises means for processing said voice or data from and to the vehicles' users. This option enables professional or private communication between the vehicles' users mutually and with the rest of the world.

At least one of said servers may be enabled to process requests for vehicle parking.

At least part of the vehicles (busses etc.) may belong to a public transportation system; information about said transportation system may be exchanged with users of vehicles not belonging to the public transportation system. This option enables gearing of the private vehicles to the public transportation system.

At least one of said servers may be enabled to process orders from the vehicles' users referring to hiring transportation room or transportation means.

At least one of said servers may be enabled for automatic processing vehicle accidents, enabling sophisticated dynamic planning of rescue capacity etc.

The following notes may be made referring to the function and architecture of the mediator system:

The mediator system may have the function of a gateway between the mobile telecommunication network (e.g. GSM, GPRS, UMTS) and the various servers (via e.g. the internet).

The mediator may also have the function of a proxyserver used for caching and/or security purposes.

The mediator system may also have a portal function, via which the services suppied by the various servers may be organized, displayed and e.g. billed. Such a portal may also be “personalized”, that is, each user may set, within the portal environment, user preferences etc. like preferred (traffic) news, music channel etc. Also a traffic network administrator may be enabled, by such a portal/mediator, to receive information about the drivers' preferences, traffic behaviour etc.

The mediator may also be enabled to supply peer-to-peer communication between car drivers which are within the same traffic area, thus enabling “local car chat” or “local car broadcasting”, which might be valuable in case of emergency, fog etc. The mediator thus may prevent that local peer-to-peer messages take relative many resources of the internet and the servers linked via the internet. Besides, the mediator system may comprise means to set-up, via the car boxes of adjacent cars, local ad-hoc networks e.g. based on IEEE 802.11 (Wireless LAN) or Bluetooth standards.

Moreover, the mediator may be enabled to urge local car boxes to setup a link to an information transmitting system, as e.g. proposed in applicant's WO9935629, describing an information system for a traffic network. Information is transmitted by, said information transmitting system, to data receivers (car boxes) in vehicles. The traffic network is broken down into information regions characterised by region-identification codes which may be set using local beacon transmitters, but which, as indicated above, alternatively may be set by means of the mediator system.

The mediator system may be used by several different communication operators, e.g. via different communication networks. In other words, the mediator system may serve several different operators and may preferrably be enabled to “hand-over” between different communication networks.

The mediator system may support, in addition to conventional (internet related) protocols, the “Wireless Application Protocol” (WAP) and/or the “I-mode” protocol. Both protocols are fit to enable mobile communication terminals (including the “car boxes”) to be used as internet terminal. The mediator may be able to detect, e.g. from the car box's ID or by analyzing the format of the received data (“parsing”), and to apply the right terminal protocol.

Finally, it is noted that an important function of the mediator system may be the fact that the IP data streams can be optimally adapted to the fanciful behaviour of mobile radio channels. For instance, short radio breaks may be considered, by the IP network, as data congestion, causing the TCP network control means to react with a “slow start”, resulting relative mean transmission speeds.

### FIGURES

FIG. 1 shows an exemplary architecture of the system according to the invention.

FIG. 2 shows an exemplary embodiment for “remote traffic speed control”.

### EXEMPLARY EMBODIMENTS

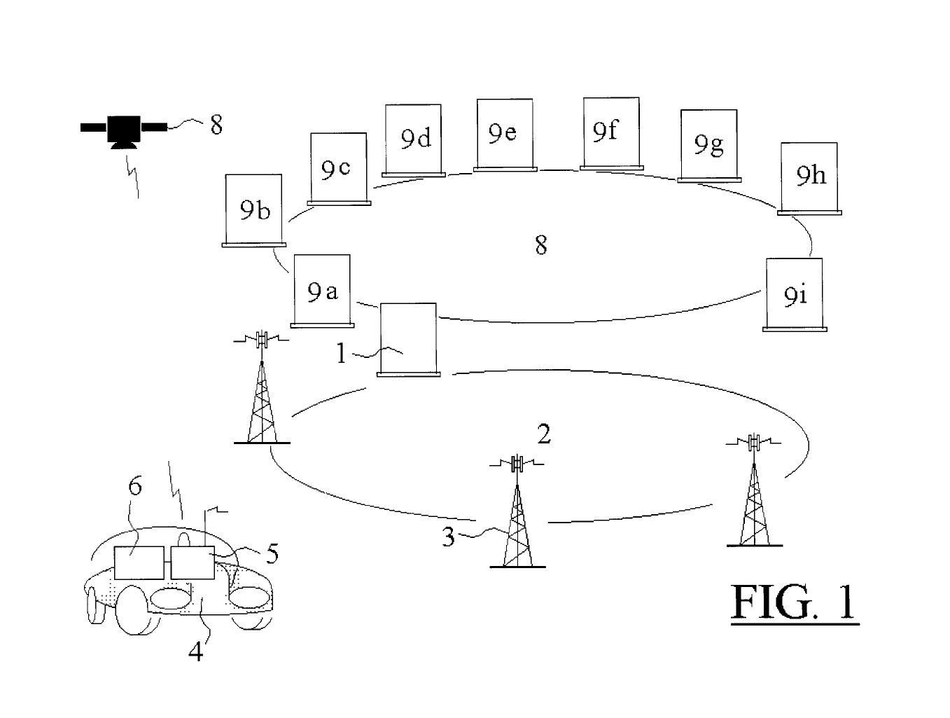

FIG. 1 shows a schematic exemplary embodiment of the present invention. Shown is a mediator 1 which is—at one side—connected to a communication system 2, comprising base stations 3, thus being able to exchange data or voice with a vehicle 4, via a vehicle's communication module 5 (“car box”), which is enabled to communicate with the car's users by means of an interface not shown or, via a vehicle control system 6, with the vehicle's hardware—the engine etc., via sensors and actuators—or control software. Communication module 5 may also be able to communicate with a satellite 7 for communication or localisation purposes.

Mediator 1 is—at the other side, via an IP-based computer service network (internet) 8—connected to several traffic or vehicle related servers 9a . . . i.

Each vehicle 4 is enabled by module 5 to communicate via the communication system 2—GSM, GPRS, UMTS—if desired via the internet—with mediator system 1. Mediator 1 serves as a central connection point for all kinds of services—enabled by various servers 9a . . . i—relevant for traffic control, vehicle control and maintenance, accounting and billing related to the usage of the vehicles (taxes, insurance fees), as well as business and private communications.

The local communication module 5 (the “car box”) comprises means for exchanging—via the vehicle control system 6—data between the vehicles' software or hardware and server 9a, comprising means for processing said data related to the vehicles' software or hardware. For instance server 9a may register the vehicles' fuel consumption and advise the car driver to visit a (preferred) fuel pump. Server 9a may also comprise means for registering the vehicles' maintenance state and notify the driver to visit a (preferred) maintenance or repair workshop. More options in the domain of monitoring the hardware of software of vehicles by server 9a are possible.

Communication module 5 also comprises vehicle location means via the terrestrial system 2 or via the (GPS) satellite 7, enabled for exchanging data relative to the vehicles' location. Server 9b, accessable via mediator 1, comprises means for processing said location data. Server 9b is able to offer various services based on registering the vehicles' location. Server 9b can also supply the vehicle's location to the other servers 9a . . . i, for instance to server 9a, to be able to present to the car driver about the nearest fuel pump or repair shop. Server 9b may also be able to compute—based on their subsequent locations—the speed of the cars.

Server 9c comprises means for planning and scheduling the use of vehicles 4 belonging to a company's car fleet. This option may enable “just-in-time” instead of present permanent car leasing.

Server 9d comprises means for dynamic (self-adapting to changes in traffic streams and capacity fluctuations) route planning. Server 9b may be used to supply data for such “dynamic traffic routing”: numbers of cars present in various roadway areas and their speed (flow). Based on those data server 9d may control the traffic flow by taking rerouting measures by means of remote controlled traffic signs, direction boards etc.

Servers 9e comprises means for billing or taxing for the use of the vehicles, dependent on the vehicle's (engine) characteristics (via vehicle control system 6), location, speed, etc. (e.g. via module 5), time-of-the-day, etc. Server 9e may also comprise means for billing vehicle related insurance etc. Below this option has been further elaborated.

The “car box”, of course, is enabled for the exchange of voice or data between the vehicles' users and server 9f, comprising means for processing said voice or data from and to the vehicles' users. This option enables professional or private communication between the vehicles' users mutually and with the rest of the world.

Server 9g is enabled to process requests for vehicle parking, in cooperation with location server 9b.

Part of the vehicles 4 may be part of a public transportation system (taxi's, busses etc.). Information about said transportation system may be exchanged with users of vehicles not belonging to the public transportation system. This option enables gearing of the private vehicles to the public transportation system. Server 9h is enabled to process orders from the vehicles' users referring to hiring transportation capacity in a taxi, bus, underground, train etc.

Finally, server 9i is enabled for automatic processing vehicle accidents, enabling sophisticated dynamic planning of rescue capacity etc. For automatic detection of vehicle accidents, server 9i may be triggered by control system 6, for instance when the vehicles “air bags” are actuated.

As stated above, the operation of the system according the invention is further explained by taking the use of servers 9b and 9e. This elaboration is partly based on the contents of applicant's dutch patent application NL . . . .

Server 9e may comprise means for billing or taxing for the use of the vehicles, dependent on the vehicle's (engine) characteristics (via vehicle control system 6), location, speed, etc. via module 5), time-of-the-day, etc. Server 9e may also comprise means for billing vehicle related insurance etc. Server 9e may co-operate with server 9b, which is fit for for registering and/or processing the location data of individual cars and for supplying that data to the other servers 9a . . . i.

The car 4 comprises the communication module (transceiver) 5, which is connected to the vehicle control system 6. The mobile network 2 computes the car's location at each moment. Each car's location can be forwarded—via mediator 1—to server 9b which distributes the location data to (e.g.) server 9e. Server 9e is fit to charge a tax for the use (in real kilometers) of each car, instead of or additional to fixed road tax schemes. Besides for “real kilometer taxation”, insurance companies may use server 9e to charge “real kilometer” insurance fees, based on the real use of each car.

For the sake of billing each car has to send a unique car identifier to server 9e. Use may be made of the already available communication identifier (e.g. SIM) of module 5. It may be preferred to have the mediator 1 retrieve the communication identifier, valid within the domain of the mobile communication network 2, and supply a unique car identifier—based on said communication identifier—which is valid within the domain of the IP based network 8. Mediator 1 thus may supply such car identifiers to all servers 9 when needed for their respective services, e.g. for billing such services.

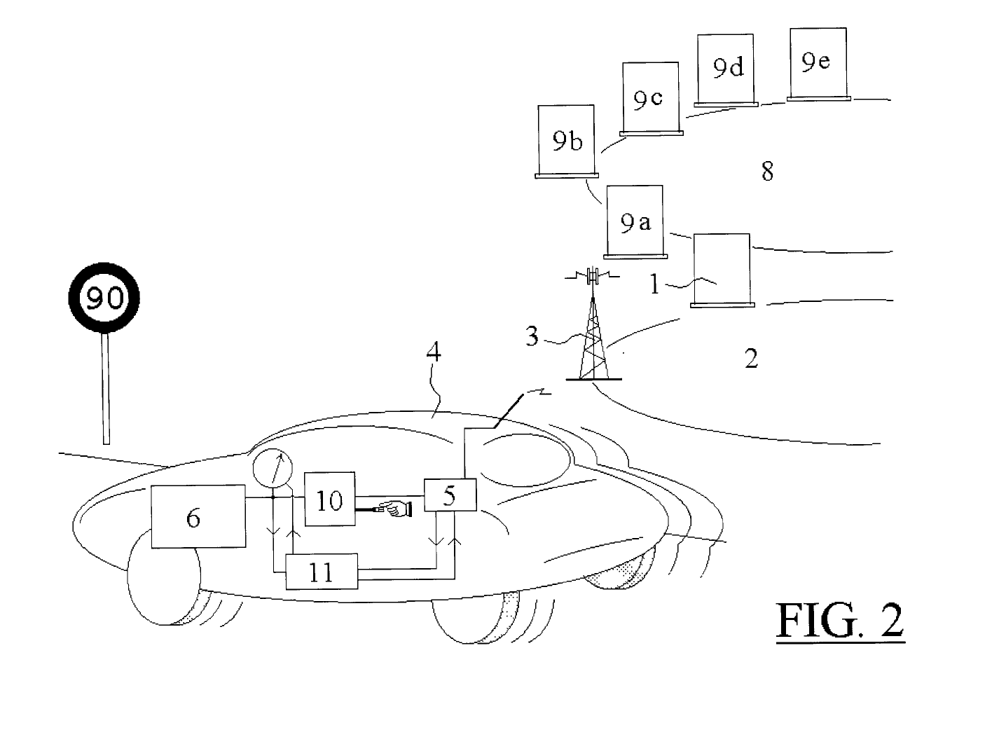

Besides computation, accumulation and billing of “car kilometers”, server 9e (or another server, e.g. server 9b) may also be used for “speed related services” like cruise control support and charging for speed offences, as discussed below with reference to FIG. 2.

Server 9e may be linked to a map database (in the same or another server) comprising data relative to the various roadways and/or traffic areas and the permitted (maximum) speeds there. Server 9e may broadcast to each individual car the local maximum speed in the relevant area (roadway). The local maximum speed value may be downloaded (and updated periodically) to each individual car by means of the link formed by the connection between server 9e, IP network 8, mediator 1, network 2, base station 3 and each car's transceiver 5. The downloaded maximum speed may be compared regularly with the car's actual speed, monitored by it's vehicle control system 6. Both, the downloaded maximum speed and the actual car speed may be displayed to the car driver and an (auditive and/or visual) warning may be given to the driver if the permitted maximum speed is exceeded. An advanced option may be set when using an (advanced) cruise control system 10: the downloaded maximum speed may be input to the cruise control system as reference (desired) speed parameter, resulting in setting and automaticly maintaining a car speed which is equal to the locally permitted maximum speed. When the car enters a roadway area with a different maximum speed or when the maximum speed is changed by the traffic network administrator or the traffic police e.g. in case of local traffic congestion e.g. due to a car accident, fog etc., the car speed could be adapted, by cruise control 10, automatically (or semi-automatically, after requesting the car driver's consent) to the new maximum speed.

The car's equipment and the servers 9b and/or 9e could also be enabled to monitor each individual car's speed and to register and bill each car's speed trespasses. Calculation of the car speed may be executed locally, by means of each car's vehicle control module 6, or centrally, by means of e.g. server 9b, viz. by detecting the car's location at subsequent moments. Speed excessions may be integrated with the excession periods and be fined accordingly.

1. A service mediator system being linked to vehicles in a traffic network, via local communication means (5) in said vehicles, enabled to communicate, via a communication network (2), with said service mediator system (1), and said service mediator system being linked, via a server network (8), to various servers (9a . . . i).

2. Service mediator system according to claim 1, wherein that said vehicles comprise means (6) for exchanging data between the relevant vehicles' software or hardware, while at least one of said servers comprises means for processing said data related to the vehicles' software or hardware.

3. Service mediator system according to claim 2, wherein at least one of said servers comprises means for registering the vehicles' fuel consumption.

4. Service mediator system according to claim 2, wherein at least one of said servers comprises means for registering the vehicles' maintenance state.

5. Service mediator system according to claim 1, wherein said local communication means comprise vehicle location means, enabled for exchanging data relative to the vehicles' location, while at least one of said servers comprises means for processing said location data.

6. Service mediator system according to claim 2 or 5, wherein at least one of said servers comprises means for registering the vehicles' locations.

7. Service mediator system according to claim 6, wherein at least one of said servers comprises means for planning and scheduling the use of the vehicles.

8. Service mediator system according to claim 6, wherein at least one of said servers comprises means for route planning.

9. Service mediator system according to claim 6, wherein at least one of said servers comprises means for billing the use of the vehicles.

10. Service mediator system according to claim 9, wherein at least one of said servers comprises means for billing vehicle related tax.

11. Service mediator system according to claim 9, wherein at least one of said servers comprises means for billing vehicle related insurance.

12. Service mediator system according to claim 1, wherein said local communication means comprise means for the exchange of voice or data with the vehicles' users, while at least one of said servers comprises means for processing said voice or data from and to the vehicles' users.

13. Service mediator system according to claim 12, wherein at least one of said servers is enabled to process requests for vehicle parking.

14. Service mediator system according to claim 12, at least part of said vehicles belonging to a public transportation system, wherein information about said transportation system is exchanged with users of vehicles not belonging to the public transportation system.

15. Service mediator system according to claim 12, wherein at least one of said servers is enabled to process orders from said users referring to hiring transportation facilities in said vehicles belonging to the public transportation system.

16. Service mediator system according to claim 1, 2, 5 or 6, wherein at least one of said servers is enabled for automatic processing vehicle accidents.

17. Service mediator system according to claim 1, enabled for being a gateway between the telecommunication network (2) and the server network (8).

18. Service mediator system according to claim 1, enabled for being a a proxyserver enabled for caching and/or security purposes.

19. Service mediator system according to claim 1, enabled for being a portal, enabled for organizing and/or displaying and/or billing the services suppied by the various servers.

20. Service mediator system according to claim 19, said portal being enabled to be “personalized” by registering preferences relating to the various vehicles and/or their users.

21. Service mediator system according to claim 20, a traffic network administrator being enabled by said portal, to receive information about the relevant preferences.

22. Service mediator system according to claim 1, enabled for peer-to-peer communication between the communication means of vehicles within the same traffic area.

23. Service mediator system according to claim 1, comprising means to set-up ad-hoc local networks comprising the local communication means (5) of adjacent vehicles.

24. Service mediator system according to claim 1, enabled to urge the local communication means (5) to set-up a link to an information transmitting system.

25. Service mediator system according to claim 1, enabled to be used by several different communication operators via different communication networks (2).

26. Service mediator system according to claim 25, enabled to “hand-over” between said different communication networks.

27. Service mediator system according to claim 1, enabled to support the “Wireless Application Protocol” (WAP) and/or the “I-mode” protocol.

28. Service mediator system according to claim 27, enabled to detect an ID of the local communication means (5) and to use the applicable protocol in conformity with the detected ID.

29. Service mediator system according to claim 1, enabled to detect an ID of the local communication means (5) and to supply said ID to one of more of said servers.

30. Service mediator system according to claim 27, enabled for analyzing the format of data received from the local communication means (5) and to use the applicable protocol in conformity with said data format.

31. Service mediator system according to claim 1, comprising means to adapt data streams in the server network (8) to the behaviour of the data streams in the communication network (2).

32. Service mediator system according to claim 1, at least one server being fit for registering and/or processing the location data of individual vehicles and at least one server comprising means for billing and/or taxing for the use of the vehicles based on the location data.

33. Service mediator system according to claim 32, one of said servers being linked to a map database comprising data relative to the various roadways and/or traffic areas and the permitted speeds there, said server broadcasting to individual vehicles the local maximum speed in the relevant area or roadway.

34. Service mediator system according to claim 33, the downloaded maximum speed being input to a cruise control system as reference speed parameter, resulting in setting and automaticly maintaining a vehicle speed which is equal to the locally permitted maximum speed.

35. Service mediator system according to claim 33, one or more servers being enabled to monitor the speed of individual vehicles and to register and bill speed excessions relative to the local maximum speed.

36. Service mediator system according to claim 35, calculation of the vehicle speed being executed locally, by means of the relevant vehicle's control module (6).

37. Service mediator system according to claim 35, calculation of the vehicle speed being executed centrally, by detecting the relevant vehicle's location at subsequent moments.

38. Service mediator system according to claim 35, speed excessions being integrated with the excession periods and be fined accordingly by means of one of said servers.

39. Cruise control system for a vehicle, comprising means (5) for receiving, via a service mediator system (1) according to claim 33, a locally permitted maximum speed value as reference speed parameter for said vehicle, and means for setting and automaticly maintaining a vehicle speed which is equal to said maximum speed value.
